(19) United States
(12) Patent Application Publication
(10) Pub. No.: US 2007/0226002 A1
(43) Pub. Date: Sep. 27, 2007

(54) Financial gaming system and method

(76) Inventors: Jeremy Tyra, Austin, TX (US); Gordon Graves, Austin, TX (US)

Correspondence Address: STEVEN W. SMITH, 7237 BIRCHWOOD DRIVE, DALLAS, TX, 75240, US

(21) Appl. No.: 11/716,907

(22) Filed: Mar. 12, 2007

Related U.S. Application Data
(60) Provisional application No. 60/785,258, filed on Mar. 23, 2006.

(51) Int. Cl. G06Q 10/00

(52) U.S. Cl. 705/1

(57) ABSTRACT

A gaming system and method within a gaming establishment having a plurality of electronic gaming devices for a player to play games of chance or skill. A central database stores a financial account for the player. Each of the plurality of gaming devices communicates with the central database either directly or through a central accounting system. An identification device uniquely identifies the player and is utilized by the player to activate a selected gaming device. When the selected gaming device is activated, an account balance for the player is retrieved from the central database. The selected gaming device maintains a record of the player's account balance while the player plays the game, and reports the updated balance to the central database when the player finishes playing. The player can then activate another gaming device and begin playing with his updated account balance. The account may be linked to external financial networks enabling the player to redeem his winnings at redemption devices external to the gaming establishment.

### CROSS-REFERENCE TO RELATED APPLICATIONS

This application claims benefit of U.S. Provisional Patent Application No. 60/785,258, filed Mar. 23, 2006, the disclosure of which is hereby incorporated by reference herein.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates to financial systems for gaming establishments such as casinos and bingo halls. More particularly, and not by way of limitation, the present invention is directed to a system and method for using an individual identification device such as a financial gaming card inside and outside of such establishments.

For many years, electronic gaming devices were designed to accept only coins. With newer technology, such devices were equipped with optical scanners for accepting paper currency and with magnetic strip readers for accepting prepaid cards. Regardless of the method used to input money, the devices required that the player cash out before moving to another gaming device or leaving the gaming establishment.

In recent years, another advance referred to as “ticket-in/ticket-out” enables a player to print out an encoded ticket from the electronic gaming device currently being played. The encoded ticket contains information regarding the player's cash balance. The player can then take the encoded ticket to another gaming device where the ticket is input, and the player's cash balance is transferred to the new device. At the end of play, however, the player still has to cash out before leaving the gaming establishment.

In another advance described in U.S. Pat. No. 5,655,966 to Werdin, Jr. et al., an electronic gaming device is disclosed that accepts major credit cards issued by financial institutions. When a player swipes his credit card in the gaming device, the device communicates with a remote verification center to verify the player's available credit limit. The player may then request a credit on the gaming device up to the credit limit of his credit card. If the player loses money while playing the game, his credit card account is charged. If the player wins money, the winnings are credited directly back to the player's credit card account.

Some jurisdictions however prohibit the use of credit accounts for playing games of chance. Werdin does not address this problem. Additionally, some jurisdictions prohibit the payout of cash or cash equivalents from games of chance. Werdin does not address this problem.

What is needed in the art is a system and method for financing games of chance or skill that eliminates the need for a player to cash out when leaving a gaming device or a gaming establishment, while overcoming the shortcomings of the prior art. The present invention provides such a system and method.

### BRIEF SUMMARY OF THE INVENTION

In one aspect, the present invention is directed to a gaming system by which a player may utilize credits in a financial account to play a game of chance or skill at a gaming device within a gaming establishment. The system includes means for establishing the financial account for the player; means for adding credits to the financial account, wherein an account balance for the player is stored in a central database; and means for issuing an identification device to the player. The identification device is utilized by the player to activate the gaming device and to input the player's identification information to the gaming device. The system also includes means for retrieving the player's account balance from the central database when the gaming device is activated by the player's identification device; means for updating the player's account balance while the player plays the game on the gaming device; means for determining that the player has finished playing the game; and means for sending the player's updated account balance to the central database in response to a determination that the player has finished playing the game. The system may also include redemption means either at the gaming establishment or external to the gaming establishment for the player to redeem all or part of the account balance. The external redemption means may be linked to the player's account through an external financial network.

In another aspect, the present invention is directed to a method of enabling a player to utilize credits in a financial account to play a game of chance or skill at a gaming device within a gaming establishment. The method includes the steps of establishing the financial account for the player; adding credits to the financial account, wherein an account balance for the player is stored in a central database; and issuing to the player an identification device, which is utilized by the player to activate the gaming device and to input the player's identification information to the gaming device. The method also includes reading by the gaming device, the player's identification information from the identification device; retrieving the player's account balance from the central database in response to reading the player's identification device; updating the player's account balance in the gaming device while the player plays the game on the gaming device; determining that the player has finished playing the game; and sending the player's updated account balance from the gaming device to the central database in response to a determination that the player has finished playing the game. The method may also include redeeming the account balance at the gaming establishment or at a redemption device external to the gaming establishment, wherein the redemption device is linked to the player's account through an external financial network.

In another aspect, the present invention is directed to a gaming system enabling a player to play a game of chance or skill within a gaming establishment having a plurality of gaming devices. The system includes a central database for storing a financial account for the player; means for linking each of the gaming devices with the central database; means for uniquely identifying the player; and means for retrieving an account balance for the player from the central database when the player activates a selected gaming device and the player is uniquely identified. The system also includes means for determining the player's winnings or loses while the player plays the game; and means for updating the player's account balance in the central database when the player finishes playing the game. The means for uniquely identifying the player may be a biometric identification device or an identification device issued to the player. Thus, the system enables the player to play a plurality of game devices without having to cash out. In one embodiment, the games are played sequentially while in another embodiment, the player may play a plurality of games simultaneously.

### BRIEF DESCRIPTION OF THE SEVERAL VIEWS OF THE DRAWING

In the following, the essential features of the invention will be described in detail by showing preferred embodiments, with reference to the attached figures in which:

FIG. 1 is a simplified block diagram of an exemplary embodiment of the system of the present invention; and

FIG. 2 is a flow chart illustrating the steps of an exemplary embodiment of the method of the present invention.

### DETAILED DESCRIPTION OF THE INVENTION

The present invention provides a gaming system by which a player may access one or more financial accounts via a card or other identification device. The identification device may be utilized at a gaming device. The identification device provides the player with access to multiple stored accounts (debit, credit, and stored value) for each player. The player may access the accounts, for example, by inserting or touching the identification device to a gaming device, passing the identification device over an RFID reader, or by presenting the identification device to a waiter, clerk, or cashier to add or deduct from the accounts in accordance with rules set up by the operator of the system.

The system accesses one or more of the financial accounts and adds or subtracts credits utilized for playing a game of chance or skill at the gaming device. The system adds credits to the financial accounts related to game winnings. The player may take his card or other identification device to other gaming devices or to retail outlets within the establishment or anywhere else in the world. In jurisdictions that prohibit the use of credit accounts for playing games of chance, the card must be a debit card or must link to a funded gaming account. In jurisdictions that prohibit cash payouts from gaming devices, the system limits the use of winnings to the exchange of credits for goods or services in the gaming establishment or at participating merchants.

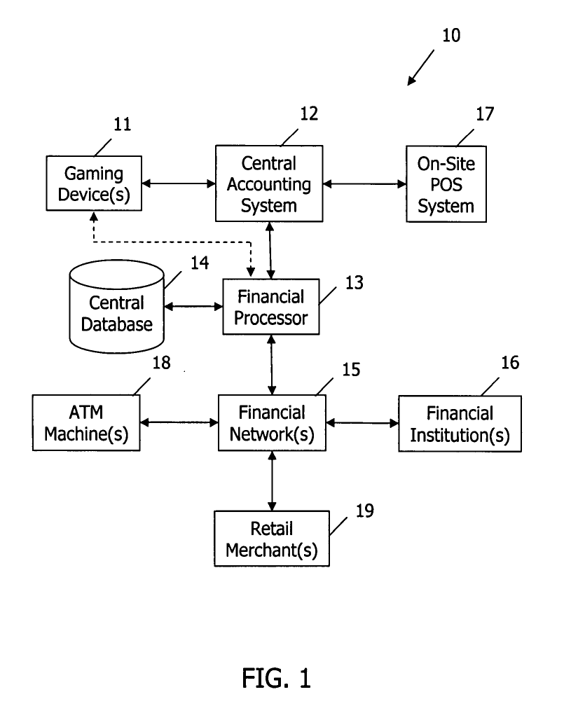

FIG. 1 is a simplified block diagram of an exemplary embodiment of the system 10 of the present invention. In a gaming establishment, one or more gaming devices 11 are connected to a Central Accounting System 12. A player begins play at one of the gaming devices by inputting identification information. The player may input the identification information in any suitable manner such as typing an ID number on a keypad, swiping a credit or debit card in a magnetic strip reader, placing an RFID tag near a reader, placing an optically coded token near an optical reader, placing a smart card near a reader, plugging in a USB identification device, inputting biometric information, and the like. In one embodiment, the gaming establishment issues the player a multi-purpose identification card.

Once the player's identification has been entered, the gaming device sends a message to the Central Accounting System 12 requesting the current balance in the player's account. The Central Accounting System sends a message to a Financial Processor 13 to retrieve the player's current balance from an associated central database 14. The Financial Processor responds with the player's current balance, and the Central Accounting System logs the information and passes the balance to the gaming device 11.

As the player plays the gaming device 11, the gaming device may maintain the player's account balance or may send the result of each play to the Central Accounting System 12 to be logged. The player may indicate he is finished playing, for example, by extracting his identification card from the gaming device or pressing a button on the gaming device. The player may also be logged out when a timer expires. In any case, when the player is finished playing, the gaming device sends a message to the Central Accounting System indicating that the player has logged out. When the Central Accounting System receives this message, it sends the player's updated balance to the Financial Processor 13 for storing in the central database 14.

In an alternative embodiment, the gaming device 11 interfaces directly with the Financial Processor 13, obtaining the player's account balance when the player's identification is entered, and reporting the player's ending balance when the player is finished playing.

The Financial Processor 13 connects to one or more Financial Networks 15. If the player used a credit card or debit card linked to an account at an associated Financial Institution 16, credits may be moved from the player's account to the associated Financial Institution at predetermined intervals such as the end of each day.

The Financial Processor 13, as a normal course of business, facilitates the movement of credits from the card issuer (in the preferred embodiment, the gaming establishment) to the Financial Institutions 16.

Once the player has left the gaming device 11, his account balance is updated and is available for use at another gaming device. Alternatively, the player may use his multi-purpose identification card to access and use his available credits in exchange for goods or services within the gaming establishment through an on-site POS system 17. The player may also cash out, or may leave the gaming establishment without cashing out and retain his balance in his account. The multi-purpose identification card may be linked through the Financial Networks 15 to various external redemption points such as ATM Machines 18 and Retail Merchants 19, where the player may redeem his winnings.

In some jurisdictions, the player can withdrawal his winnings in cash through an ATM machine. Other jurisdictions, however, prohibit cash payout of game winnings. In such jurisdictions, the Financial Processor 13 does not allow the winnings to be withdrawn at ATM machines. A number of Retail Merchants 19 may participate with the gaming establishment in a redemption program. At these merchant locations, the player may redeem his winnings in exchange for goods and/or services.

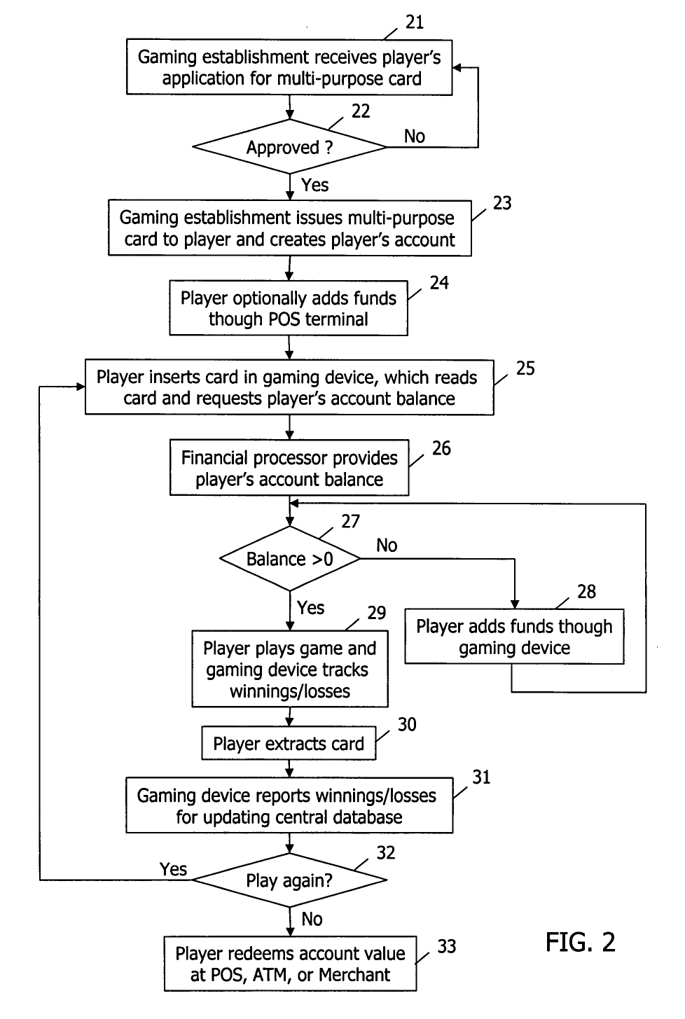

FIG. 2 is a flow chart illustrating the steps of an exemplary embodiment of the method of the present invention. At step 21, the gaming establishment receives a player's application for a multi-purpose identification card. The card functions as a medium with which to access a financial account. Each financial institution and financial network has criteria that govern the issuance of a financial account. These criteria include, but are not limited to, the types of information that must be collected, required financial strength for approval/denial, and how the card must be issued. At step 22, the player's application is either approved or denied, based on these criteria. If the application is denied, the player may apply again after making necessary changes in his financial condition. If the application is approved, the process moves to step 23 where the gaming establishment issues the card to the player and creates an account associated with or “linked” to that player. Depending upon the requirements of the financial institution, the participant may receive the card immediately or may have to wait some period of time.

At step 24, the player may add credits to the account. This may be done at the same POS terminal where the player applied for the account or at another POS terminal in the gaming establishment. At step 25, the player inserts his card in a gaming device 11. The gaming device reads the card and requests the player's account balance from the Central Accounting System 12. The Central Accounting System requests the account balance from the Financial Processor 13, which retrieves this information from the central database 14 and provides it to the Central Accounting System at step 26. The player may also “log in” to a gaming device using another method such as an RFID tag or smart card.

At step 27 it is determined whether or not the player's account balance is greater than zero. If not, the process moves to step 28 where the player adds credits to his account through the gaming device 11. The process then returns to step 27 where it is determined that the balance is greater than zero and the process moves to step 29. The player then plays the game, and the gaming device uses the player's winnings or losses to maintain a current account balance. The game is played by first deciding how much to wager on that game. If the account has sufficient credits, then the amount of the wager will be deducted and the game will begin. If there are not sufficient credits for the current wager then the player must add more credits to the account in order to play or change the wager. When the player is finished playing on this particular gaming device he extracts his card at step 30. At step 31, the gaming device reports the player's winnings/losses or the updated account balance. The report may be made to the Central Accounting System 12, which then reports the account balance to the Financial Processor 13 for storing in the Central Database 14. Alternatively, the gaming device may report the player's winnings or losses directly to the Financial Processor. Based upon the outcome of the game, the player wins, loses, or breaks even on their wager. If applicable, the corresponding debit or credit is made to the overall account balance. The new balance is then available for the next play of the gaming device or for play on a different gaming device within the gaming establishment.

At step 32 it is determined whether or not the player desires to play again on either the same or a different gaming device. If so, the process returns to step 25 where the player inserts his card in a selected gaming device and the gaming device requests the player's account balance from the Central Accounting System 12. However, if the player does not desire to play again, the process moves to step 33 where the player may choose to cash out, for example, through the on-site POS system 17. The player may also choose to leave the gaming establishment and redeem the credits available on the account either at an ATM machine for cash withdrawal or to exchange credits for merchandise at a location that accepts the player's card. Note that the player has the option to leave the establishment at any time after the account is funded, and he can redeem the account balance at an ATM machine or participating merchant. The player is not required to cash out when he leaves the gaming establishment.

Some players like to play several adjacent gaming devices at the same time. In another embodiment of the present invention, the Central Accounting System 12 controls the plurality of gaming devices and the central database 14 associated with the Financial Processor 13 so that the player can simultaneously activate a plurality of gaming devices. The Central Accounting System and the Financial Processor maintaining a current running balance in the central database, which reflects the activity on all of the player's activated gaming devices.

In another embodiment, the system of the present invention uniquely identifies the player utilizing a biometric identification device such as a retina scanner, fingerprint scanner, facial recognition scanner, or the like. In this embodiment, there is no identification card. The biometric identification device may be located at the gaming device 11, and upon recognition of the player's biometric information by the biometric identification device, the player's account balance is retrieved from the Central Database 14 and provided to the gaming device. When the player is finished playing, he may, for example, press an end-of-play button on the gaming device or scan his biometric information again.

Although preferred embodiments of the present invention have been illustrated in the accompanying drawings and described in the foregoing Detailed Description, it is understood that the invention is not limited to the embodiments disclosed, but is capable of numerous rearrangements, modifications, and substitutions without departing from the scope of the invention. The specification contemplates any and all modifications that fall within the scope of the invention defined by the following claims.

What is claimed is:

1. A gaming system by which a player may utilize credits in a financial account to play a game of chance or skill at a gaming device within a gaming establishment, said system comprising:
means for establishing the financial account for the player;
means for adding credits to the financial account, wherein an account balance for the player is stored in a central database;
means for issuing an identification device to the player, said identification device being utilized by the player to activate the gaming device and to input the player's identification information to the gaming device;
means for retrieving the player's account balance from the central database when the gaming device is activated by the player's identification device;
means for updating the player's account balance while the player plays the game on the gaming device;
means for determining that the player has finished playing the game; and
means for sending the player's updated account balance to the central database in response to a determination that the player has finished playing the game.

2. The system according to claim 1, further comprising redemption means within the gaming establishment for redeeming the credits in the player's account.

3. The system according to claim 1, further comprising redemption means external to the gaming establishment for redeeming the credits in the player's account, wherein the redemption means is linked to the player's account through an external financial network.

4. The system according to claim 3, wherein the external redemption means includes an ATM machine for making a cash withdrawal.

5. The system according to claim 3, wherein the external redemption means includes a retail merchant that accepts credits from the player's account in exchange for merchandise or services.

6. The system according to claim 3, wherein the external redemption means includes a financial institution for making a cash withdrawal.

7. The system according to claim 1, wherein the means for adding credits to the financial account includes a point-of-sale (POS) terminal within the gaming establishment.

8. The system according to claim 1, wherein the gaming device includes means for adding credits to the financial account.

9. The system according to claim 1, wherein the identification device is selected from a group consisting of:
a financial card with a magnetic strip having the player's identification information encoded thereon;
an RFID tag having the player's identification information encoded thereon;
a smart card having the player's identification information encoded thereon;
a token with an optical code having the player's identification information encoded thereon; and
a USB device having the player's identification information stored thereon.

10. The system according to claim 1, wherein the means within the gaming device for determining that the player has finished playing the game is selected from a group consisting of:
a card-reader slot having means for sensing when the player removes the identification device from the slot, said identification device comprising a card with a magnetic stripe having the player's identification information encoded thereon;
a button for indicating that the player has finished playing the game; and
a timer for indicating when a predefined time period for playing the game has expired.

11. A method of enabling a player to utilize credits in a financial account to play a game of chance or skill at a gaming device within a gaming establishment, said method comprising:
establishing the financial account for the player;
adding credits to the financial account, wherein an account balance for the player is stored in a central database;
issuing an identification device to the player, said identification device being utilized by the player to activate the gaming device and to input the player's identification information to the gaming device;
reading by the gaming device, the player's identification information from the identification device;
retrieving the player's account balance from the central database in response to reading the player's identification device;
updating the player's account balance in the gaming device while the player plays the game on the gaming device;
determining that the player has finished playing the game; and
sending the player's updated account balance from the gaming device to the central database in response to a determination that the player has finished playing the game.

12. The method according to claim 11, further comprising redeeming the credits in the player's account at a redemption device within the gaming establishment.

13. The method according to claim 11, further comprising redeeming the credits in the player's account at a redemption device external to the gaming establishment, wherein the external redemption device is linked to the player's account through an external financial network.

14. The method according to claim 13, wherein the step of redeeming the credits in the player's account at an external redemption device includes making a cash withdrawal at an ATM machine external to the gaming establishment.

15. The method according to claim 13, wherein the step of redeeming the credits in the player's account at an external redemption device includes exchanging credits from the player's account for merchandise or services at a retail merchant.

16. The method according to claim 13, wherein the step of redeeming the credits in the player's account at an external redemption device includes making a cash withdrawal at a financial institution external to the gaming establishment.

17. The method according to claim 11, wherein the step of adding credits to the financial account includes adding credits utilizing a point-of-sale (POS) terminal within the gaming establishment.

18. The method according to claim 11, wherein the step of adding credits to the financial account includes adding credits utilizing the gaming device.

19. The method according to claim 11, wherein the step of issuing an identification device to the player includes issuing an identification device selected from a group consisting of:
a financial card with a magnetic stripe having the player's identification information encoded thereon;
an RFID tag having the player's identification information encoded thereon;
a smart card having the player's identification information encoded thereon;
a token with an optical code having the player's identification information encoded thereon; and
a USB device having the player's identification information stored thereon.

20. The method according to claim 11, wherein the step of determining that the player has finished playing the game includes determining by the gaming device that an event has occurred from a group consisting of:
removal of the identification device from a card-reader slot in the gaming device;
pressing of a button for indicating that the player has finished playing the game; and
expiration of a timer for indicating when a predefined time period for playing the game has expired.

21. A gaming system enabling a player to play a game of chance or skill within a gaming establishment having a plurality of gaming devices, said system comprising:
a central database for storing a financial account for the player;
means for linking each of the gaming devices with the central database;
means for uniquely identifying the player;
means for retrieving an account balance for the player from the central database when the player activates a selected gaming device and the player is uniquely identified;
means for determining the player's winnings or loses while the player plays the game; and
means for updating the player's account balance in the central database when the player finishes playing the game.

22. The gaming system according to claim 21, wherein the means for uniquely identifying the player is a biometric identification device.

23. The gaming system according to claim 21, wherein the means for uniquely identifying the player is an identification device issued to the player.

24. The gaming system according to claim 21, further comprising:
a central controller for controlling the plurality of gaming devices and the central database;
means within the selected gaming device for determining that the player has left the selected gaming device; and
means within the selected gaming device for sending a notification to the central cotroller that the player has left the selected gaming device;
wherein the central controller enables the player to activate a second gaming device upon receiving the notification that the player has left the selected gaming device.

25. The gaming system according to claim 21, further comprising:
a central controller for controlling the plurality of gaming devices and the central database;
wherein the central controller enables the player to simultaneously activate a plurality of gaming devices while maintaining a current balance in the central database.
